(19) United States
(12) Patent Application Publication
(10) Pub. No.: US 2016/0210651 A1
(43) Pub. Date: Jul. 21, 2016

(54) SCPGOEM LOYALTY & COUPON SYSTEM

(71) Applicant: BOND BRAND LOYALTY INC., Mississauga (CA)

(72) Inventor: Carlo PIRILLO, Missussauga, CA (US)

(21) Appl. No.: 14/994,306

(22) Filed: Jan. 13, 2016

Related U.S. Application Data
(60) Provisional application No. 62/103,620, filed on Jan. 15, 2015.

(51) Int. Cl. G06Q 30/02

(52) U.S. Cl. CPC G06Q 30/0226; G06Q 30/0225

(57) ABSTRACT

A loyalty server method and system confirms that a purchased product of an SCPG/OEM is listed in a product code database, that the purchased product was purchased using a financial institution product of a particular financial institution, and that the member purchasing the product and requesting a reward is listed in a loyalty database. In response, currency is added to a reward account of the member and the SCPG/OEM is provided access to member contact information to contact the member directly. At least a portion of the reward can be provided by the SCPG/OEM.

### CROSS-REFERENCE TO RELATED APPLICATIONS

This application is based on, and claims benefit of, U.S. provisional patent application No. 62/103,620 filed Jan. 15, 2015, the entire content of which is hereby incorporated herein by reference.

### FIELD OF THE INVENTION

The present invention generally relates to loyalty programs, and in particular to systems and methods implementing a direct-to-consumer loyalty program that combines at least one Financial Institution (FI) with a plurality of Suppliers of Consumer Package Goods (SCPG) and/or Original Equipment Manufacturer (EOM) partners.

### BACKGROUND

Loyalty programs are well known in the art. Typically, these programs are implemented by retailers, based on the purchase of products supplied by one or more Suppliers of Consumer Package Goods (SCPG) and/or Original Equipment Manufacturer (EOM) partners. Previous attempts by SCPG\OEMs to implement direct-to-consumer loyalty programs that are retailer agnostic have resulted in less than optimal results due to a burden on the consumer to provide a suitable “proof of purchase” and/or an inability to consistently and comprehensively link the submitted “proof of purchase” with a specific consumer and, in some cases, to consistently and comprehensively link the submitted “proof of purchase” with a validated purchase. These problems can be attributed to the fact that the information needed to positively link a given “proof of purchase” with a specific consumer and a particular validated purchase typically resides only with the retailer that handled the particular purchase transaction. In this case, a direct-to-consumer loyalty program that is retailer-agnostic suffers a limitation in that it lacks information that may be critical for implementing the program.

Thus a problem to be solved is how to implement an effective direct-to-consumer loyalty program that does not depend on information held by any given retailer.

### SUMMARY

A loyalty server method and system confirms that a purchased product of an SCPG/OEM is listed in a product code database, that the purchased product was purchased using a financial institution product of a particular financial institution partner, and that the member purchasing the product and requesting a reward is listed in a loyalty database. In response, currency is added to a reward account of the member and the SCPG/OEM is provided access to member contact information to contact the member directly. At least a portion of the reward can be provided by the SCPG/OEM.

### BRIEF DESCRIPTION OF THE DRAWINGS

FIG. 1 is a block diagram of a system.

FIG. 2 illustrates one embodiment of operation of the system and method as a flow diagram.

### DETAILED DESCRIPTION

Systems and methods described herein enable the creation and operation of a direct-to-consumer loyalty program by a coalition of SCPG\OEMs and at least one financial institution (FI) partner. A program reference name of CONVERGE™ may be used for such systems and methods because of the coalition. The incorporation of credit and/or debit card instruments of the FI partner into the program enables the system to positively link validated transactions, specific consumers, and “proof of purchase” independently of any retailers involved in the transaction. In particular, the coalition loyalty program combines the tracking and earning benefit of a credit or debit card with the promotional offers and product content of the SCPG\OEMs. The CONVERGE loyalty program as implemented by systems and methods of the invention allows members to easily participate in loyalty constructs that are implemented directly by SCPGs\OEMs.

In the past, customers making purchases of eligible products at any retailer could participate by submitting their receipt (via image capture or any other future receipt submission capability). This receipt submission from the customer has been available for some time and, although certain controls are provided, it is difficult to ensure that customers actually made the purchase themselves.

With the introduction of a credit or debit card as both an accelerator and purchase data vehicle, the CONVERGE loyalty program as implemented by systems and methods of the invention minimizes the possibility of fraud. Each receipt submitted by a consumer who is a program member is cross referenced with the credit or debit card transaction history ensuring that the customer submitting the receipt completed the transaction. The credit or debit card also eliminates another challenge for SCPG\OEMs looking to execute direct to consumer programs; SCPG\OEMs are able to remain retailer agnostic since their products are sold through numerous retail chains. This challenge combined with the fact that the majority of redemptions in these types of programs are ‘micro’ redemptions (often below $15) the usage of traditional redemption vehicles such as gift cards are not a viable option.

By utilizing the credit or debit card as a redemption vehicle by posting cash rewards (e.g., rebates, incentives, discounts) directly on the card, the CONVERGE loyalty program removes the need for retailer involvement and avoids the expense associated with one time use redemption cards which involve costly delivery costs.

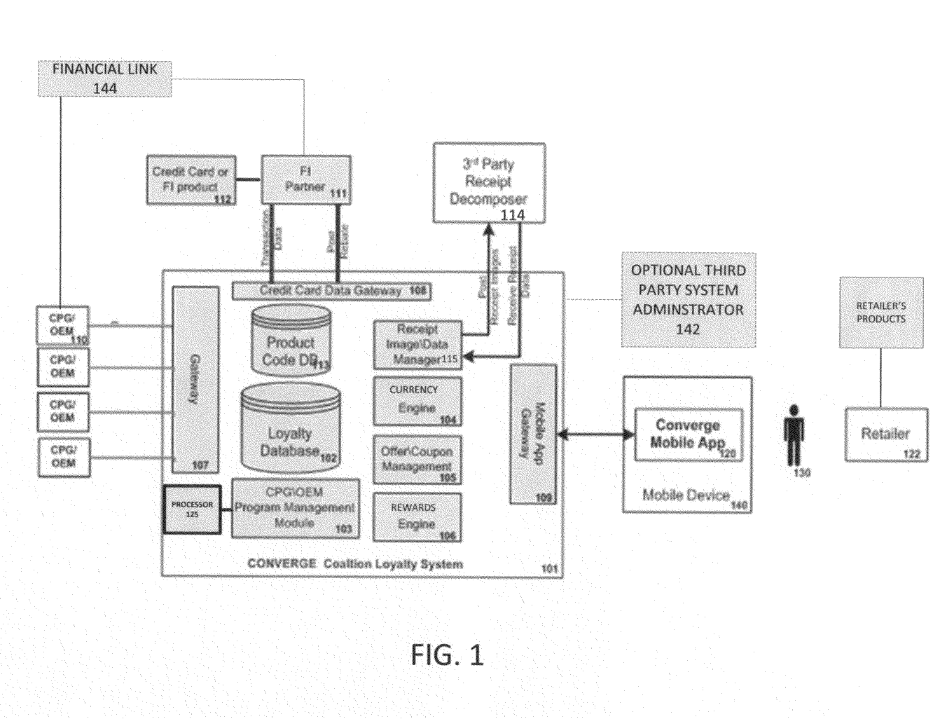

Referring to FIG. 1, a SCPG\OEM\FI coalition loyalty control center system 101 interfaces to a SCPG\OEM\FI loyalty application 120 (e.g., an APP) which resides on and is executed by a mobile device 140 of a member 130 of the program. The APP 120 comprises processor executable instructions stored in a tangible, non-transitory memory device of the mobile device which, when executed by a processor of the mobile device, interfaces with a gateway 109 of the system 101. The system 101 manages a coalition loyalty program involving a financial institution (FI) 111 and a curated collection of SCPGs and OEMs 110. The SCPG\OEM\FI coalition loyalty program allows consumers to join as members 130 of the program by signing up for a credit or debit card 112 or other FI product 112 of the FI partner 111. Once registered for the program, the member 130 can download the mobile application 140 that interfaces with the SCPG\OEM\FI coalition loyalty system 101 via a mobile app gateway 109.

In one form, the loyalty system 101 is a server comprising a loyalty database 102 comprising a tangible, non-transitory memory device which stores profiles for members participating in the program and their reward accounts. (Alternatively, the accounts can be separately stored in a separate database.) The loyalty system 101 also includes an SCPG\OEM\FI program management module 103 comprising processor executable instructions stored in a tangible, non-transitory memory device which, when executed by a processor 125, controls and manages program rules and individual partner specifics, and a reward engine module 106 of processor executable instructions stored in a tangible, non-transitory memory device which, when executed by processor 125, calculates earned rewards based on purchases of each individual member 130.

Members 130 will be presented with specific offers related to purchasable products of the SCPG\OEM(s) involved in the program. The offers will take on such forms, but not limited to, offers, discounts, coupons, rewards & other promotions. SCPGs\OEMs will have the ability to initiate offers via a partner gateway 107 by associating an offer to a specific product contained within a product code database 113 comprising a tangible, non-transitory memory device which stores codes of eligible products. The gateway 107 is configured to provide the SCPG/OEM 110 access to the loyalty database 102 to obtain contact information of the member 130 by accessing the profile of the member 130 in the loyalty database 102 so that the SCPG/OEM 110 can contact the member 130 directly with various offers and/or promotions.

Participating SCPGs\OEMs 110 can access the Converge system 101 to manage offers and/or coupons via a management module 105 of processor executable instructions stored in a tangible, non-transitory memory device and to review and monitor current offer campaigns via the partner gateway 107.

Once a participating member 130 completes a purchase at any retailer 122 which contains an eligible product from a participating SCPG\OEM 110, the member 130 can submit their receipt via the mobile application 120 on their mobile device 140. In one embodiment, a 3^{rd} party service for receipt decomposition 114 is used. In one form, the decomposer 114 comprises processor executable instructions stored in a tangible, non-transitory memory device which, when executed by a processor, decomposes received receipts to determine receipt data including the product purchased and FI product purchasing the product. This service will be managed via the receipt image & data manager module 115 of processor executable instructions stored in a tangible, non-transitory memory device. In another embodiment, an automated receipt capture mechanism via a mobile wallet will be leveraged. For example, the automated receipt capture mechanism can be the rewards redemption system and method (CPG/OEM loyalty program) disclosed in U.S. patent application Ser. No. 14/205,672 filed Mar. 12, 2014, the entire disclosure of which is incorporated herein by reference.

Based on the earned product and its eligibility, participating members will earn financial benefits in the form of a cash reward calculated via a currency engine 104 of processor executable instructions stored in a tangible, non-transitory memory device which, when executed by the processor 125, will award currency to the participating member 130 based on the rewards due the member as calculated by the rewards engine 106. These rewards will be applied to the members' credit or debit card via a cash reward adjustment based on a predetermined frequency posted to the account via the credit\debit card gateway 108. Once posted, members will be able to view earned and applied rewards via their standard card account balance mechanism. The reward will also be posted in their monthly (or other established frequency) statement.

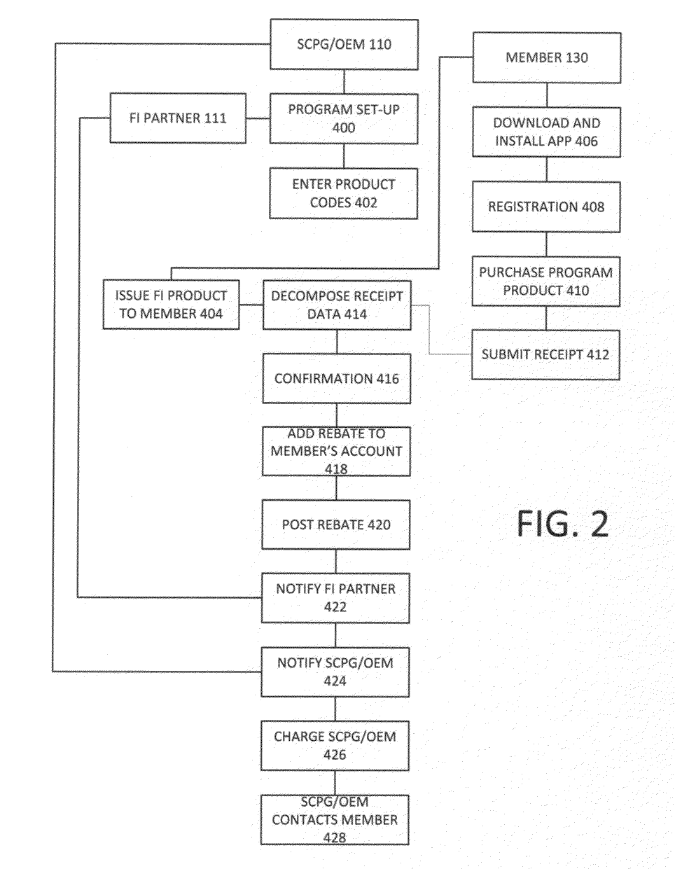

Referring to FIG. 2, one embodiment of the operation of the system and method is illustrated as a flow diagram. Initially, an SCPG/OEM 110 sets up a program at 400 by accessing management module 103 executed by processor 125 via gateway 107 and by coordinating with an FI partner 111. The SCPG/OEM 110 enters one or more product codes into database 113 at 402 for products which are part of the program. A member 130 obtains an FI product 112 from FI partner 111 at 404, downloads and installs at 406 the Converge mobile APP 120 to their mobile device 140 via gateway 109, and registers for the program at 408. By registering, the member's profile is stored in loyalty database 102.

Member 130 makes various purchases with a retailer 122 using the FI product 112 and purchases one or more of the products which are part of the program at 410. The member 130 submits a copy of the purchase receipt at 412 for the one or more of the products which are part of the program via the APP 120 via gateway 109 to the receipt image/data manager 115. For example, the member 130 can use their mobile device 140 to capture the receipt and send it to manager 115. The mobile device 140 can take a picture of the receipt, provide a link to data of the receipt, and/or transfer an electronic version of the receipt.

The receipt image(s) is provided by the receipt image/data manager 115 to decomposer 114 which provides receipt data via manager 115 to the management module 103 at 414. At 416, the management module 103 confirms: (1) that the purchased product(s) is listed in product code database 113, (2) that the purchased product(s) was purchased by using one of the FI products 112 of the FI partner 111, and (3) that the member 130 purchasing the product and requesting the reward is listed in loyalty database 102.

For each confirmed transaction, the manager 103 adds currency (e.g., points, cash, credit) to the member's account via currency engine 104 at 418. In response, the currency engine 104 periodically posts at 420 a reward for the member on the member's FI product account by notifying FI partner 111 via gateway 108 at 422. The SCPG/OEM 110 is notified of the purchase details at 424 and provided access to the profile of the member 130. Some or all of the reward can be provided by SCPG/OEM 110 of the program at 426, in which case the FI partner 111 charges the SCPG/OEM 110 for their portion of the reward and any associated administrative fees to be paid to the FI partner 111 or to be paid by the FI partner 111 to an optional third party system administrator 142. For example, a financial link 144 between the financial institution 111 and the SCPG/OEM 110 is configured to allow the financial institution 111 to charge the SCPG/OEM 110 for a portion or all of the reward and/or any associated administrative fees. Optionally, the link 144 can be provided by the loyalty server system 101, it can be via a debit/credit card system, or it can be a direct billing arrangement. The SCPG/OEM 110 is now in a position to determine the contact information of the member 130 by accessing the profile of the member 130 in the loyalty database 102 so that the SCPG/OEM 110 can contact at 428 the member 130 directly with various offers and/or promotions.

It is contemplated that various changes could be made in the above constructions, products, and methods without departing from the scope of the invention as defined in the appended claims. The specification and drawings are accordingly to be regarded in an illustrative rather than a restrictive sense.

We claim:

1. A system for implementing a direct-to-consumer rewards program of a coalition of at least one Financial Institution (FI) and a plurality of Suppliers of Consumer Package Goods (SCPG) and/or Original Equipment Manufacturer (EOM) partners, said system comprising:
an FI server maintained by the FI, the FI server being configured to maintain an account database storing account information for each one of a plurality of consumers, purchase information of purchases made by said consumers using one or more designated FI products offered by the FI, and a respective rewards account recording rewards earned by each said consumer in accordance with the direct-to-consumer rewards program;
a loyalty system server configured to interface with instances of a rewards APP and the FI server to implement the direct-to-consumer rewards program, the loyalty system server comprising:
a processor;
a memory storing a product code database including product codes of eligible products that may be eligible for a reward as part of the direct-to-consumer rewards program, and a loyalty database including profiles of consumers who are registered as participating members of the direct-to-consumer rewards program;
a non-transitory computer readable storage medium containing processor executable instructions for controlling the processor to implement the direct-to-consumer rewards program by:
registering a consumer in the loyalty database as a participating member of the direct-to-consumer rewards program;
responsive to registering the consumer in the loyalty database, causing an instance of the rewards APP to be downloaded to a mobile device of the participating member, the mobile device installing the rewards APP to facilitate participation by the participating member in the direct-to-consumer rewards program;
subsequently interfacing with the rewards APP installed on the participating member's mobile device to receive purchase information of a specific purchase made by the participating member, the purchase information including information identifying the participating member, information identifying a specific product purchased by the participating member, and information identifying an FI product used by the participating member to pay for the purchase;
interfacing with the FI server, using the received purchase information, to determine whether or not the identified FI product is a designated FI product;
interfacing with the product code database to determine whether or not the identified specific product is eligible for an award;
interfacing with the loyalty database to determine whether or not the identified participating member is actually a participating member of the direct-to-consumer rewards program;
calculating, responsive to determining that the identified FI product is a designated FI product, and that the identified specific product is eligible for an award, and that the identified participating member is actually a participating member of the direct-to-consumer rewards program, an award amount due to the participating member under the direct-to-consumer rewards program; and
interfacing with the FI server to cause the FI server to add currency corresponding to the calculated award amount to the rewards information of the identified participating member.

2. The system of claim 1 wherein the purchase information of a specific purchase made by the participating member comprises a receipt generated by a retailer, and wherein the system further comprises a decomposer configured to decompose the received receipt to determine the information identifying the specific product purchased and the FI product used by the participating member to pay for the purchase.

3. The system of claim 1 further comprising a gateway configured to provide each SCPG/OEM partner access to the product code database to store product codes of eligible products supplied by that SCPG/OEM partner.

4. The system of claim 3 wherein the loyalty system server is further configured to
identify a source SCPG/OEM partner of the specific product purchased by the participating member; and
interface with the gateway to enable the identified source SCPG/OEM partner to access the loyalty database 102 to obtain contact information of the participating member.

5. The system of claim 4, further comprising a financial link between the FI and the identified source SCPG/OEM partner, said financial link configured to enable the FI to charge the identified source SCPG/OEM partner for at least a portion of the calculated reward amount.

6. The system of claim 5 wherein the financial link is provided by the loyalty system server.

7. A processor executable method implementing a direct-to-consumer rewards program of a coalition of at least one Financial Institution (FI) and a plurality of Suppliers of Consumer Package Goods (SCPG) and/or Original Equipment Manufacturer (EOM) partners, said method comprising:
maintaining, in an FI server of the FI, an account database storing account information for each one of a plurality of consumers, purchase information of purchases made by said consumers using one or more designated FI products offered by the FI, and a respective rewards account recording rewards earned by each said consumer in accordance with the direct-to-consumer rewards program
storing, in a memory of a loyalty system server configured to interface with instances of a rewards APP and the FI server to implement the direct-to-consumer rewards program, a product code database including product codes of eligible products that may be eligible for a reward as part of the direct-to-consumer rewards program, and a loyalty database including profiles of consumers who are registered as participating members of the direct-to-consumer rewards program;
registering, by a processor of the loyalty system server, a consumer in the loyalty database as a participating member of the direct-to-consumer rewards program;
responsive to registering the consumer in the loyalty database, the processor causing an instance of the rewards APP to be downloaded to a mobile device of the participating member, the mobile device installing the rewards APP to facilitate participation by the participating member in the direct-to-consumer rewards program;
subsequently interfacing, by the processor, with the rewards APP installed on the participating member's mobile device to receive purchase information of a specific purchase made by the participating member, the purchase information including information identifying the participating member, information identifying a specific product purchased by the participating member, and information identifying an FI product used by the participating member to pay for the purchase;
interfacing, by the processor, with the FI server, using the received purchase information, to determine whether or not the identified FI product is a designated FI product;
interfacing, by the processor, with the product code database to determine whether or not the identified specific product is eligible for an award;
interfacing, by the processor, with the loyalty database to determine whether or not the identified participating member is actually a participating member of the direct-to-consumer rewards program;
calculating, by the processor, responsive to determining that the identified FI product is a designated FI product, and that the identified specific product is eligible for an award, and that the identified participating member is actually a participating member of the direct-to-consumer rewards program, an award amount due to the participating member under the direct-to-consumer rewards program; and
interfacing, by the processor, with the FI server to cause the FI server to add currency corresponding to the calculated award amount to the rewards information of the identified participating member.

8. The method of claim 7 wherein the purchase information of a specific purchase made by the participating member comprises a receipt generated by a retailer, and wherein the method further comprises decomposing by the processor the received receipt to determine the information identifying the specific product purchased and the FI product used by the participating member to pay for the purchase.

9. The method of claim 7 further comprising providing, by a gateway, each SCPG/OEM partner access to the product code database to store product codes of eligible products supplied by that SCPG/OEM partner.

10. The method of claim 9, further comprising identifying, by the processor, a source SCPG/OEM partner of the specific product purchased by the participating member;
and the processor interfacing with the gateway to enable the identified source SCPG/OEM partner to access the loyalty database 102 to obtain contact information of the participating member.

11. The method of 10 further comprising providing a financial link between the FI and the identified source SCPG/OEM partner, said financial link configured to enable the FI to charge the identified source SCPG/OEM for at least a portion of the calculated reward amount.

12. The method of claim 11 wherein the financial link is provided by a loyalty system server.
